(19) United States
(12) Patent Application Publication
(10) Pub. No.: US 2010/0296696 A1
(43) Pub. Date: Nov. 25, 2010

(54) PAPER SHEET PROCESSING APPARATUS AND PAPER SHEET PROCESSING METHOD

(75) Inventor: Takuma Akagi, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/723,819

(22) Filed: Mar. 15, 2010

(30) Foreign Application Priority Data
May 22, 2009 (JP) 2009-124416

(51) Int. Cl. G06K 9/00

(52) U.S. Cl. 382/101

(57) ABSTRACT

In a sorting apparatus, an image on the paper sheet is read by a scanner, and from the read image on the paper sheet, characters of the destination information are recognized by a character recognition unit. If the address information included in the destination information as a character recognition result obtained by the character recognition unit matches with the address information having an out-migrant included in relocation information previously registered in a database, it is judged by a judgment unit whether the receiver on the paper sheet is the out-migrant. If it has been judged that the receiver on the paper sheet is the out-migrant, a label on which the address information of a new address of the out-migrant is written is attached to an attaching position considering a description area of the destination information on the paper sheet by a label attachment unit.

### CROSS-REFERENCE TO RELATED APPLICATIONS

This application is based upon and claims the benefit of priority from prior Japanese Patent Application No. 2009-124416, filed May 22, 2009, the entire contents of which are incorporated herein by reference.

### BACKGROUND OF THE INVENTION

1. Field of the Invention

The present invention relates to a paper sheet processing apparatus and a paper sheet processing method that sort out paper sheets, e.g., a postal matter on which receiver information such as a name is written together with address information.

2. Description of the Related Art

A sorting apparatus recognizes address information written on a paper sheet to sort out the paper sheet in conventional examples. A staff judges whether a postal matter having information of an address subjected to relocation such as moving is for an out-migrant or an in-migrant based on, e.g., name information of a receiver. Further, the staff who has determined that the postal matter is to be delivered to the out-migrant manually writes the new address or put a label on which the new address is printed. To automate such an operation, there has been recently suggested a sorting system that registers information concerning a mover (an out-migrant) in an address information database in advance and recognizes whether a receiver corresponds to an out-migrant or an in-migrant by character recognition processing.

However, in the character recognition processing that simply calculates a similarity with respect to each character in a dictionary, a character string of the out-migrant and a character string of the in-migrant may be possibly erroneously recognized. That is, assuredly judging whether the receiver corresponds to the out-migrant or the in-migrant is not easy when the general character recognition processing based on similarity of each character alone is performed. Therefore, in the sorting processing with respect paper sheets including paper sheets for movers, secure confirmation aid for destination information based on a human system or an improvement in a recognition accuracy for out-migrants and in-migrants is a problem.

### BRIEF SUMMARY OF THE INVENTION

It is an object to the present invention to provide a paper sheet processing apparatus and a paper sheet processing method that can assuredly process a paper sheet having specific sorting information written thereon.

According to an aspect of the present invention, there is provided a paper sheet processing apparatus that processes a paper sheet, comprising a storage unit which stores relocation information including information concerning an out-migrant whose address has changed, a read unit which reads an image on the paper sheet, a recognition unit which performs character recognition with respect to destination information including address information and receiver information from the image on the paper sheet read by the read unit, a judgment unit which judges whether the paper sheet is for an out-migrant by comparing the destination information as a recognition result obtained by the recognition unit with the relocation information stored in the storage unit, a judgment unit which judges an attaching position of a label having information concerning an out-migrant given thereto based on a destination information description region on the paper sheet in a case where the judgment unit determines that the paper sheet is for the out-migrant, and a label attachment unit which attaches the label having the information concerning the out-migrant given thereto to the attaching position on the paper sheet determined by the judgment unit.

According to an aspect of the present invention, there is provided a paper sheet processing apparatus which processes a paper sheet, comprising a storage unit which stores relocation information including address information with an out-migrant, information indicative of a relocated out-migrant and information indicative of a registration time, a read unit which reads an image on the paper sheet, an address recognition unit which performs character recognition with respect to address information included in destination information from the image on the paper sheet read by the read unit, and a receiver recognition unit which recognizes whether receiver information included in the destination information of the paper sheet is an out-migrant or an in-migrant based on character recognition weighted in accordance with an elapsed time from the registration of the relocation information in a case where the address information as a recognition result obtained by the address recognition unit coincides with the address information of the relocation information.

According to an aspect of the present invention, there is provided a paper sheet processing apparatus which processes a paper sheet, comprising a storage unit which stores relocation information including information concerning an out-migrant whose address has changed, a read unit which reads an image on the paper sheet, a recognition unit which recognizes destination information including address information and receiver information from the image of the paper sheet read by the read unit, and an information input unit which accepts input of the destination information through a keyboard in a state where the image on the paper sheet whose destination information cannot be recognized by the recognition unit is displayed, and informs a warning that the destination information input through the keyboard corresponds to the relocation information in a case where the destination information input through the keyboard coincides with the relocation information stored in the storage unit.

According to an aspect of the present invention, there is provided a paper sheet processing apparatus which processes a paper sheet, comprising a storage unit which stores relocation information including information concerning an out-migrant whose address has changed, a read unit which reads an image on the paper sheet, a recognition unit which performs character recognition with respect to destination information including address information and receiver information from the image on the paper sheet read by the read unit, a judgment unit which judges whether a receiver of the paper sheets is an out-migrant or an in-migrant in a case where the address information of the destination information as a recognition result obtained by the recognition unit coincides with the address information of the relocation information stored in the storage unit, a recording unit which records the number of out-migrants determined by the judgment unit and the number of in-migrants determined by the same in association with the relocation information, and a counting unit which counts the number of out-migrants and the number of in-migrants recorded by the recording unit in accordance with each relocation information during a predetermined period.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view schematically showing a structural example of a sorting apparatus (a sorting system) as a paper sheet processing apparatus;

FIG. 2 is a flowchart for roughly explaining a flow of a first processing example;

FIG. 3A is a view showing an example of a paper sheet as a label attachment target;

FIG. 3B is a view showing an example of a label attaching position with respect to the paper sheet depicted in FIG. 3A;

FIG. 4A is a view showing an example of a paper sheet as a label attachment target;

FIG. 4B is a view showing an example of a label attaching position with respect to the paper sheet depicted in FIG. 4A;

FIG. 5A is a view showing an example of a paper sheet as a label attachment target;

FIG. 5B is a view showing an example of a label attaching position with respect to the paper sheet depicted in FIG. 5A;

FIG. 6A is a view showing an example of a paper sheet as a label attachment target;

FIG. 6B is a view showing an example of a label attaching position with respect to the paper sheet depicted in FIG. 6A;

FIG. 7 is a view showing an example of an aged change in rates of postal matters for an out-migrant and postal matters for an in-migrant in given address information;

FIG. 8 is a flowchart showing a flow of recognition processing for destination information according to a second processing example;

FIG. 9 is a view showing an example of a recognition result with respect to a receiver information;

FIG. 10A is a view showing an example of relocation information registered in a destination information database;

FIG. 10B is a view showing an example of the relocation information registered in the destination information database;

FIG. 11 is a flowchart for explaining a flow of recognition processing for a receiver as the second processing example;

FIG. 12 is a view showing a display example when address information of relocation information is input through a keyboard in an information input device as a third processing example;

FIG. 13 is a view showing an example of the relocation information in the destination information database;

FIG. 14 is a flowchart for explaining a flow of sorting processing for paper sheets including paper sheet counting processing according to a fourth processing example; and

FIG. 15 is a flowchart for explaining a flow of adjustment processing of the destination information database according to the fourth processing example.

### DETAILED DESCRIPTION OF THE INVENTION

An embodiment according to the present invention will now be described hereinafter with reference to the accompanying drawings.

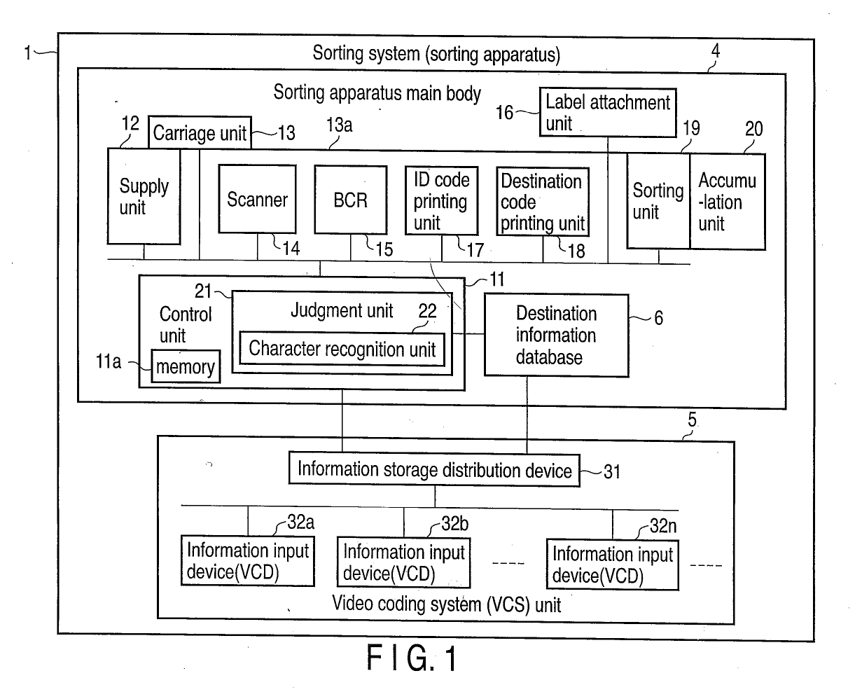

FIG. 1 is a view schematically showing a structural example of a sorting apparatus (a sorting system) 1 as a paper sheet processing apparatus according to an embodiment of the present invention.

The sorting apparatus 1 sorts out paper sheets or deliveries such as articles based on sorting information, e.g., destination information including address information. That is, the sorting apparatus 1 functions as the paper sheet processing apparatus. In this embodiment, a description will be given on the assumption that the sorting apparatus 1 as the paper sheet processing apparatus sorts out paper sheets in accordance with each section or sorts out the same in a delivery order based on destination information including address information and receiver information.

It is to be noted that the address information includes information indicative of an area (e.g., a name of a prefecture and municipalities), information indicative of a section in an area (e.g., a city block), information indicative of a location (a residence) in a section (e.g., a block number and a house (room) number) and others, and the receiver information is information indicative of a person at a destination (e.g., a name of a person, a name of a company or a name of a corporate).

A configuration of the sorting apparatus 1 will now be described.

As shown in FIG. 1, the sorting apparatus 1 includes a sorting apparatus main body 4, a video coding system (VCS) unit 5, a destination information database (a destination DB) 6.

As depicted in FIG. 1, the sorting apparatus main body 4 has a control unit 11, a supply unit 12, a carriage unit 13, a scanner 14, a barcode reader (BCR) 15, a label attachment unit 16, an ID code printing unit 17, a destination code printing unit 18, a sorting unit 19, an accumulation unit 20 and others.

The control unit 11 controls the entire sorting apparatus main body 4. The control unit 11 includes a CPU, various kinds of memories, various kinds of interfaces and others. For example, in the control unit 11, a CPU executes a program stored in a non-illustrated program memory to realize control over each unit. Further, the control unit 11 has a memory 11a that stores setting information, control information and others. Furthermore, in the control unit 11, a judgment unit 21 that judges address information of a paper sheet is provided. Moreover, the judgment unit 21 has a character recognition unit (an online OCR) 22 that recognizes destination information as character information from an image.

The supply unit 12 takes out paper sheets (e.g., postal matters) as sorting targets set by an operator one by one and supplies them to the carriage unit 13. The carriage unit 13 carries the paper sheets taken out by the supply unit 12 to each subsequent unit through the carriage path 13a.

The scanner 14 is installed on a downstream side of the supply unit 12 with respect to a direction for the paper sheets carried by the carriage unit 13. The scanner 14 reads an image on a surface where address information is written as sorting information on each paper sheet taken out by the supply unit 12 and carried trough the carriage path 13a by the carriage unit 13. The barcode reader 15 reads barcode information such as an address code or an ID code printed on each paper sheet.

The label attachment unit 16 is a module that attaches a label to the paper sheet. The label attachment unit 16 attaches a label on which correct destination information is printed to a paper sheet having wrong destination information. For example, the label attachment unit 16 attaches a label on which destination information including address information of a new address (a relocation destination) is printed to a paper sheet for a person whose address has been changed by moving.

The label attachment unit 16 has a function of attaching a plurality of types of labels having different sizes and shapes to paper sheets. A plurality of types of labels can be set in a non-illustrated accommodating portion in the label attachment unit 16. That is, the label attachment unit 16 has a function of setting a plurality of types of labels in the accommodating portion, a function of selecting and taking out a desired type of label from the plurality of types of labels set in the accommodating portion, a function of printing destination information on the selectively taken-out label, and a function of attaching the label on which the destination information is printed to a paper sheet. It is to be noted that, as the function of printing the destination information, the destination information can be printed with a font and a layout adapted to a size and a shape of a selected label (a taken-out label).

The ID code printing unit 17 prints an ID code as an identification code that is used for identifying a paper sheet (or an image on the paper sheet read by the scanner 14) with respect to the paper sheet having no barcode given thereto. The destination code printing unit 18 prints barcode information (a destination code) indicative of destination information written on the paper sheet. The destination code printing unit 18 prints a destination code indicative of a destination (a sorting destination) on the paper sheet based on the destination information determined by the judgment unit 21 or the destination information input by the information input device 32.

The sorting unit 19 sorts out each paper sheet based on the destination information. The accumulation unit 20 accumulates a paper sheet sorted by the sorting unit 19. The accumulation unit 20 has an accumulation storage in which paper sheets are stacked and a plurality of sorting pockets (not shown). Each sorting pocket is associated with a sorting destination as the destination information. That is, the paper sheet having the defined destination information is accumulated in the sorting pocket associated with the sorting destination indicated by the destination information.

The accumulation unit 20 has an accumulation storage for the VCCS (which will be referred to as a VCS accumulation storage hereinafter) in which paper sheets whose destination information cannot be defined are accumulated as paper sheets as processing targets by the VCS unit 5. The paper sheets as processing targets of the VCS unit 5 in the paper sheets whose destination information cannot be defined are accumulated in the VCS accumulation storage in the accumulation unit 20.

Moreover, the accumulation unit 20 has an accumulation storage for undirected paper sheets (which will be referred to as an undirected accumulation storage hereinafter) in which paper sheets having no sorting pocket associated with the defined destination information are accumulated. Here, address information registered in the destination information database 6 is associated with any one of the sorting pockets. It is to be noted that a paper sheet that is transferred to a new address (a paper sheets for an out-migrant) may be accumulated in the sorting pocket associated with address information of a new address, or a dedicated sorting pocket (a sorting pocket for a paper sheet directed to an out-migrant) may be set.

The judgment unit 21 judges a sorting destination based on the destination information of each paper sheet. The judgment unit 21 utilizes the character recognition unit 22 to recognize address information from an image of a paper sheet read by the scanner 14, and judges a sorting destination of each paper sheet based on the recognized address information, for example. Additionally, this unit reads address information associated with an ID code of a paper sheet having the ID code printed thereon, and judges a sorting destination of the paper sheet based on this address information. It is to be noted that the judgment unit 21 may judge a sorting destination based on address information recognized from an image on a paper sheet by character recognition or judge a sorting destination based on address information associated with an ID code in accordance with an operation mode set by an operator in advance.

The judgment unit 21 uses the character recognition unit (the online OCR) 22 to recognize destination information. The character recognition unit 22 recognizes character information as destination information from an image on a paper sheet read by the scanner 14. Further, the character recognition unit 22 has a function of detecting a destination information description region or recognizing address information and receiver information included in the destination information. The judgment unit 21 judges the destination information given to a paper sheet based on a recognition result obtained by the character recognition unit 22 and information stored in the destination DB 6. For example, the judgment unit 21 judges whether address information as a recognition result obtained by the character recognition unit 22 matches with address information stored in the destination DB 6 to determine if the recognition result is assured as the address information, or judges whether the address information as the recognition result coincides with address information of relocation information (address information with an out-migrant).

Furthermore, since the character recognition unit 22 of the judgment unit 21 functions as the online OCR, a processing time (a recognition processing time) during which character recognition (address information recognition processing) is performed is set in accordance with a carriage time of a paper sheet in the sorting apparatus main body 4. That is, the character recognition unit 22 is configured based on an algorithm that enables obtaining a recognition result of character information as address information within the recognition processing time (e.g., a time required to reach the destination code printing unit 18 after passing through the scanner 14). Moreover, the control unit 11 is configured to transfer an image of a paper sheet whose address information cannot be recognized by the character recognition unit 22 to an information storage distribution unit 31.

The destination information database (the destination DB) 6 stores destination information that is present as a destination (a sorting destination). That is, the judgment unit 21 judges whether a result of character recognition processing performed by the character recognition unit 22 is correct based on the destination information stored in the destination information database 6. Additionally, information in the destination information database 6 is appropriately updated when a person at a destination is changed or when a new destination is set.

Further, when a person of given address information is relocated, i.e., when a receiver associated with the given address information is changed, the destination information database 6 stores relocation information including, e.g., address information of a new address of an out-migrant. The relocation information is associated with address information. When the address information as a recognition information coincides with address information of the relocation information, whether a receiver is a receiver who has moved out (an out-migrant) or a receiver who has newly moved in (an in-migrant) is judged. When a receiver in the destination information is a receiver who has already relocated, it is determined that the address information of a corresponding paper sheet should be changed to address information of a new address based on the relocation information.

A configuration of the VCS (video coding system) unit 5 will now be described.

As shown in FIG. 1, the VCS unit 5 has the information storage distribution unit 31, a plurality of information input devices (video coding disks: VCD) (32a, 32b, . . . ) and others. Further, in the VCS unit 5, an offline OCR that performs character recognition as destination information based on an algorithm different from that of the character recognition unit (the online OCR) 22 may be provided in parallel to the information input devices 32.

The information storage distribution unit 31 functions as an interface between the sorting device main body 4 and each information input device 32. It is to be noted that the information storage distribution unit 31 may carry out data communication with any other sorting device through a non-illustrated server device or may access the destination information database 6.

The information storage distribution unit 31 stores information (video coding information) of an image or the like on a paper sheet having address information determined to fail in recognition by the judgment unit 21. For example, the information storage distribution unit 31 stores an image of a paper sheet and a recognition result of a character as address information obtained by the character recognition unit 22 in association with ID information (an ID code) given to this paper sheet. Furthermore, the information storage distribution unit 31 distributes video coding information (which will be referred to as coding data hereinafter) including an image of a paper sheet and a character recognition result associated with ID information to each information input device 32 in accordance with each article.

Each information input device 31 (32a, 32b, . . . ) function as a teaching device that teaches destination information. The information input device 32 (32a, 32b, . . . ) is a device through which an operator inputs destination information based on coding data including, e.g., an image of a paper sheet distributed from the information storage distribution unit 31. Moreover, in one sorting system, the plurality of information input devices 32 are connected to the information storage distribution unit 31. Each information input device 32 notifies the information storage distribution unit 31 of a processing situation or the like and performs an address information input operation based on the coding data distributed from the information storage distribution unit 31. Additionally, the information input by the operator using each information input device 32 is stored in the information storage distribution unit 31.

Further, each information input device 32 is formed of a computer having a control unit, a storage unit, a display unit, an operation unit and others. Each information input device 32 displays in the display unit an image of a paper sheet in the coding data received from the information storage distribution unit 31 and accepts input of address information or the like by the operator in a state that the image of the paper sheet is displayed in the display unit. Furthermore, each information input device 32 transfers input information input as address information by an operator as processed data (coded information) associated with an ID code of the paper sheet to the information storage distribution unit 31.

The information storage distribution unit 31 also has a function of storing information input through each information input device 32. Data stored in the information storage distribution unit 31 and input through the information input device 32 is appropriately supplied to the sorting device main body 4. As a result, the sorting device main body 4 sorts out paper sheets based on data (address information associated with an ID code) stored in the information storage distribution unit 31 and processed by the VCS unit 5. That is, the sorting device main body 4 reads an ID code given to a paper sheet whose address information has been input through the information input device 32, acquires address information (input information) of the paper sheet associated with this ID code from the information storage distribution unit 31, and sorts out the paper sheet based on the acquired address information.

In the following embodiment, a description will be given as to processing examples for efficiently performing sorting processing with respect to a destination whose destination information has been changed due to relocation or the like in the thus configured sorting device. Here, information concerning a destination whose destination information has been changed due to relocation or the like is managed as relocation information. In the following embodiment, it is assumed that the relocation information is stored in the destination information database 6.

To begin with, a first processing will be explained.

The first processing example is processing that the sorting device 1 attaches a label on which new address information of a receiver based on relocation information is written to a paper sheet for the moved receiver. Here, the relocation information includes a receiver information such as a name of an out-migrant and address information of a new address as information concerning the out-migrant as well as the corresponding address information, and it also includes receiver information such as name of an in-migrant when the in-migrant who has moved to the corresponding address is present as information concerning the in-migrant. Additionally, it is assumed that the receiver information is information other than the address information, e.g., a name of a receiver included in destination information.

It can be considered that a paper sheet having the address information registered as the relocation information written thereon is manually processed by an operator or it is processed based on the receiver information obtained as a character recognition result. Whether the paper sheet is directed to an out-migrant (a person who does not live at a corresponding address at the present) or directed to an in-migrant (a resident at a corresponding address) is judged based on the receiver information included in the destination information written on the paper sheet. That is, when processing the paper sheet having the relocation information based on a character recognition result, the character recognition unit 22 must judge whether the receiver information included in the destination information corresponds to an out-migrant or an in-migrant. When judging whether receiver information corresponds to an out-migrant or an in-migrant based on character recognition, the character recognition unit 22 judges whether the receiver information such as a name included in a character recognition result of the destination information coincides with an out-migrant or an in-migrant. When it is determined that the receiver information corresponds to an out-migrant, the sorting device 1 attaches a label on which a new address is written to the paper sheet.

However, erroneous recognition may possibly occur in the character recognition processing executed by the character recognition unit (the OCR) 22 mounted in the sorting device 1. For example, the character recognition unit 22 may possibly determine that the receiver information corresponds to a name of an out-migrant even with respect to a paper sheet on which a name of an in-migrant is written as the receiver information. Further, when the label on which the destination information of the out-migrant is attached to a region where the destination information is written on the paper sheet, humans cannot visually confirm the destination information originally written on the paper sheet (humans cannot confirm that erroneous recognition has occurred).

That is, when a label is attached in a random manner or when a label is always attached to a predetermined position, the destination information written on the paper sheet cannot be visually confirmed in some cases. Therefore, in this sorting device 1, when attaching a label for an out-migrant, the label is attached to prevent the destination information written on the paper sheet from being hidden. As a result, a person such as a deliverer can assuredly confirm the destination information written on the paper sheet.

A flow of the first processing example will now be described.

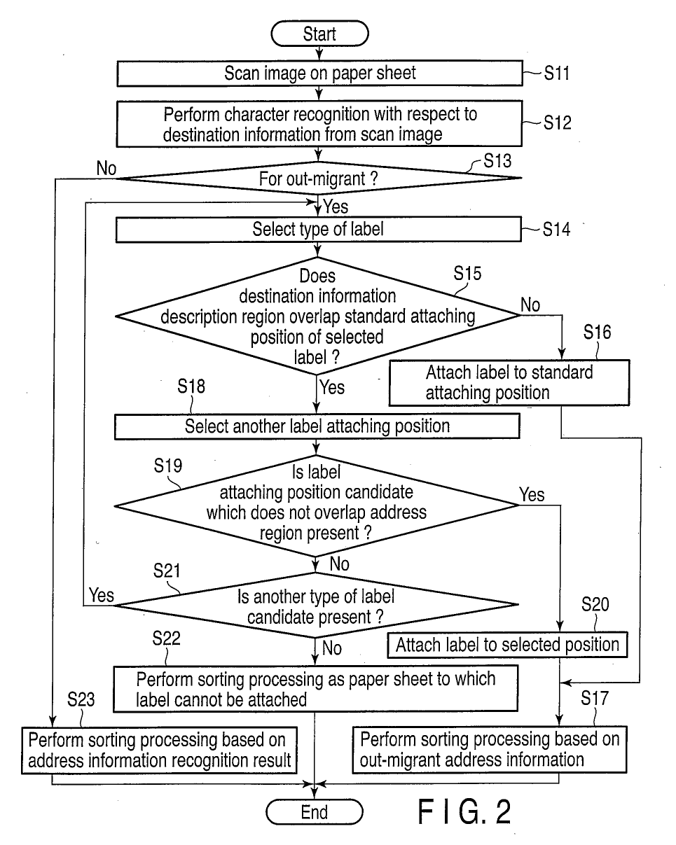

FIG. 2 is a flowchart for roughly explaining a flow of the first processing example.

First, in the sorting device 1, the paper sheets set in the supply unit 12 are taken out one by one and carried by the carriage unit 13. The scanner 14 reads an image on each paper sheet carried by the carriage unit 13 (a step S11). The image read by the scanner 14 is supplied to the character recognition unit 22 in the control unit 11. The character recognition unit 22 executes character recognition processing of recognizing character information as destination information from the image read by the scanner 14 (a step S12). However, in regard to a paper sheet having a barcode printed thereon, the barcode reader 15 recognizes destination information indicated by the barcode.

In the character recognition processing, the character recognition unit 22 detects a region (region detection) which may be a destination information description region from the image read by the scanner 14. In this region detection processing, the character recognition unit 22 detects whether a label is put on the paper sheet. When the label is put on the paper sheet, the character recognition unit 22 detects a character region in a region on the label as a destination information description region.

When the destination information description region is detected, the character recognition unit 22 detects a character string from the detected region (character string detection). When the character string is detected, the character recognition unit 22 detects each character (character detection) from the detected character string. When each character is detected, the character recognition unit 22 calculates a similarity between each detected character and each character registered in a character dictionary (not shown) to extract a character to which each character is similar (a character candidate). As character candidates, for example, a predetermined number of character candidates are selected in a similarity order. When such character candidates are selected, the character recognition unit 22 calculates a similarity between a word candidate formed of a combination of character candidates of each character and a word candidate included in destination information (address information or receiver information) stored in the destination information database to determine the destination information (the address information and the receiver information) as a character recognition result.

It is to be noted that, when paper sheets directed to persons other than an out-migrant are to be sorted in accordance with address information, address information alone included in the destination information may be first recognized in the character recognition processing executed by the character recognition unit 22. In this case, when the address information as a recognition result coincides with address information of relocation information, the character recognition unit 22 may further execute recognition processing of receiver information included in the destination information.

When a destination information recognition result is obtained by the character recognition unit 22, the judgment unit 21 judge whether the obtained destination information is destination information for an out-migrant (a step S13). The judgment unit 21 compares the destination information as the recognition result with relocation information registered in the destination DB 6 to judge whether a corresponding paper sheet is directed to the out-migrant. For example, the judgment unit 21 judges whether address information included in the destination information as the recognition result coincides with address information of the relocation information registered in the destination DB 6. When the address information as the recognition result coincides with the address information of the relocation information, the judgment unit 21 judges whether receiver information (e.g., a name of a receiver) included in the destination information as the recognition result coincides with out-migrant information (e.g., a name of an out-migrant) of the relocation information registered in the destination DB 6. When the receiver information as the recognition result coincides with the out-migrant information, the judgment unit 21 determines that the paper sheet is directed to the out-migrant.

When it is determined that the paper sheet is not directed to the out-migrant (a step S13, NO), the judgment unit 21 determines the destination information as the character recognition result obtained by the character recognition unit 22 as destination information of the paper sheet. When the destination information of the paper sheet is determined, the control unit 11 sorts out the paper sheet based on the determined destination information (a step S23). In this case, the control unit 11 prints a destination code indicative of the destination information on the paper sheet by using the destination code printing unit 18, and accumulates the paper sheet in the sorting pocket in the accumulation unit 20 associated with the destination information of the paper by using the sorting unit 19. It is to be noted that, when the destination information cannot be recognized, the control unit 11 prints an ID code on the paper sheet by using the ID code printing unit 17 and sorts out this paper sheet as a VCS paper sheet.

When it is determined that the paper sheet is directed to an out-migrant (the step S13, YES), the control unit 11 attaches a label on which out-migrant information including address information of a new address is printed to the paper sheet. First, the control unit 11 selects a type of the label attached to the paper sheet (a step S14). In the label attachment unit 16, as labels that can be attached to paper sheets, a plurality of types of labels having different sizes and shapes are set. The control unit 11 selects one from the plurality of types of labels set in the label attachment unit 16.

When the type of label is selected, the control unit 11 judges whether a standard attaching position of the selected label overlaps a destination information description region on the paper sheet (a step S15). Standard attaching positions are set to various kinds of labels set in the label attachment unit 16, respectively. Furthermore, setting information of a standard attaching position of each label is stored in, e.g., the memory 11a in the control unit 11. Moreover, the memory 11a may store information indicative of sizes or shapes of various kinds of labels set in the label attachment unit 16 or a selecting order.

When judging overlap of the attaching position of the selected label and the destination information description region, the control unit 11 determines information indicative of the destination information description region on the paper sheet based on a processing result obtained by region detection of the character recognition processing executed by the character recognition unit 22. When the destination information description region on the paper sheet is determined, the control unit 11 compares the destination information description region with the label attaching position to judge whether they overlap each other. It is to be noted that the processing at the step S15 may be executed by the label attachment unit 16. In this case, the label attachment unit 16 may acquire information indicative of the destination information description region obtained by the character recognition processing through the control unit 11.

When it is determined from the judgment that the destination information description region does not overlap the standard attaching position of the selected label (the step S15, NO), the control unit 11 attaches a label having the out-migrant information printed thereon to the standard attaching position of the label on the paper sheet by using the label attachment unit 16 (a step S16). That is, the control unit 11 supplies the information indicative of the selected label and the information indicative of the standard attaching position as the information indicative of the attaching position of the label to the label attachment unit 16 together with the out-migrant information as the sorting information of the paper sheet. The label attachment unit 16 takes out the selected type of label (a label in an initial state) from the non-illustrated accommodating portion, prints the out-migrant information on the label, and attaches the label having the out-migrant information printed thereon to the standard attaching position of the label on the paper sheet.

When the label having the out-migrant information printed thereon is attached to the paper sheet, the control unit 11 sorts out the paper sheet based on the out-migrant information (a new address) printed on the label attached to the paper sheet (a step S17). For example, the paper sheet having the label attached thereto may be sorted out based on address information of the new address, or it may be accumulated in a predetermined sorting pocket for paper sheets having labels attached thereto. As a result of such sorting processing, the paper sheet to which the label having the out-migrant information printed thereon is attached without overlapping the destination information written on the paper sheet is sorted to a sorting pocket associated with the new address or the predetermined sorting pocket.

Further, when it is determined that the destination information description region overlaps the standard attaching position on the selected label (the step S15, YES), the control unit 11 selects another attaching position different from the standard attaching position for the label as the attaching position for the label (a step S18). That is, the control unit 11 searches for a position to which the selected label can be attached without overlapping the destination information description region. It is to be noted that various kinds of techniques can be applied as the method for selecting the attaching position of the label. For example, a position which does not overlap the destination information description region may be selected from a plurality of attaching position candidates previously set with respect to the label, or a judgment may be made upon whether the attaching position of the label can be assured with an end portion of the destination information description region being determined as a reference.

When the label attaching position which does not overlap the destination information description region on the paper sheet is selected (the step S19, YES), the control unit 11 attaches the label having the out-migrant information printed thereon to the selected label attaching position on the paper sheet by using the label attachment unit 16 (a step S20). For example, the control unit 11 supplies information indicative of the selected label and the attaching position of the selected label to the label attachment unit 16 together with the out-migrant information as the sorting information of the paper sheet. The label attachment unit 16 prints the out-migrant information on a label in the initial state accommodated in the non-illustrated accommodating portion, and attaches the label having the out-migrant information printed thereon to the attaching position of the selected label on the paper sheet.

When the label having the out-migrant information printed thereon is attached to the paper sheet, the control unit 11 performs sorting processing for sorting the paper sheet based on the out-migrant information (a new address) printed on the label attached to the paper sheet (a step S17). As a result of this sorting processing, the paper sheet having the label on which the out-migrant information is printed attached thereto without overlapping the destination information written on the paper sheet is sorted to a sorting pocket associated with the new address or the predetermined sorting pocket.

Moreover, when it is determined that a position at which the selected label can be attached without overlapping the destination information description region on the paper sheet is not present (the step S19, NO), the control unit 10 determines that the selected label cannot be attached to the paper sheet. When it is determined that the selected label cannot be attached to the paper sheet, the control unit 11 judges whether another type of label can be selected from the plurality of types of labels set in the label attachment unit 16 (a step S21). When another type of label is determined to be selectable (the step S21, YES), the control unit 11 returns to the step S14 to select another type of label and again executes the processing at the step S14 and subsequent steps.

When it is determined that there is not label that can be attached to the paper sheet without overlapping the destination information even though the processing at the step S14 and subsequent steps is carried out with respect to all the types of labels set in the label attachment unit 16 (the step S21, NO), the control unit 11 sorts the paper sheet to a sorting pocket in which paper sheets for out-migrants having no label attached thereto are accumulated without attaching a label to the paper sheet (a step S22).

As described above, in the first processing example, disabling attachment of a label that overlaps the destination information description region enables assuredly confirming the destination information written on the paper sheet from the beginning. In other words, in the first processing example, if a state that the destination information written from the beginning can be visually confirmed cannot be assured, attachment of a label is prohibited. Therefore, according to the first processing example, humans can assuredly confirm paper sheets for out-migrants.

An example of an attaching position of a label selected as a selectable label by the first processing example will now be described.

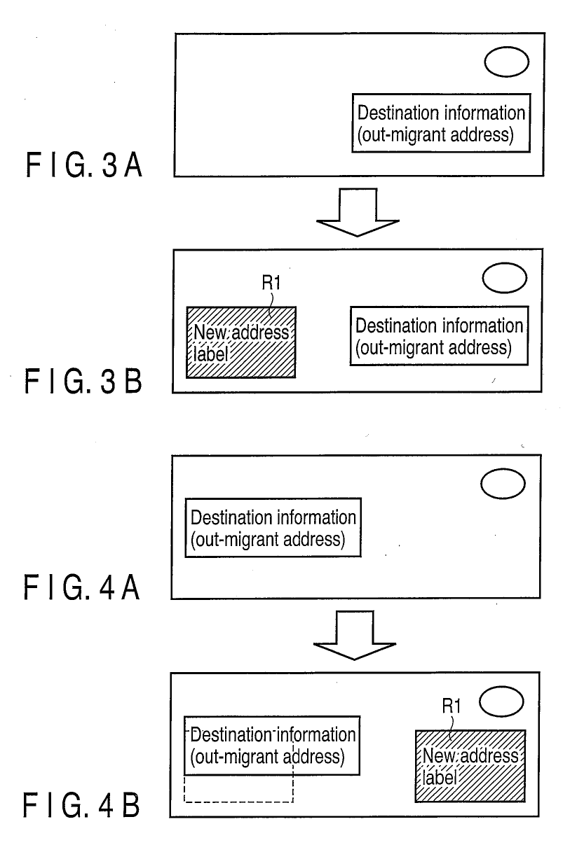

For example, FIGS. 3A, 4A, 5A and 6A are views each showing an example of a paper sheet as a label attachment target. FIGS. 3B, 4B, 5B and 6B are views each showing a label selection example and an example of a label attaching position with respect to the paper sheet shown in each of FIGS. 3A, 4A and 5A.

FIG. 3A shows a state that destination information is written in a right-side region in a horizontally long paper sheet. Additionally, FIG. 3B shows a state that a label R1 is attached to a left-side region in the paper sheet depicted in FIG. 3A. If the attaching position depicted in FIG. 3B is the standard attaching position of the label R1, the label R1 is attached to the standard attaching position of such a paper sheet as shown in FIG. 3A since the destination information description region does not overlap the standard attaching position of the label R1.

On the other hand, FIG. 4A shows a state that the destination information is written in the left-side region in the horizontally long paper sheet. Further, FIG. 4B shows a state that the same type of label R1 as that in FIG. 3A is attached to the right-side region in the paper sheet depicted in FIG. 4A. If the attaching position shown in FIG. 3B is the standard attaching position of the label R1, the destination information description region overlaps the standard attaching position of the label R1 in such a paper sheet as depicted in FIG. 4A as indicated by a dotted line in FIG. 4B. Therefore, the attaching position of the label R1 is selected in the right-side region in such a paper sheet as depicted in FIG. 4A as an attaching position of the label R1 other than the standard attaching position of the label R1 as depicted in FIG. 4B.

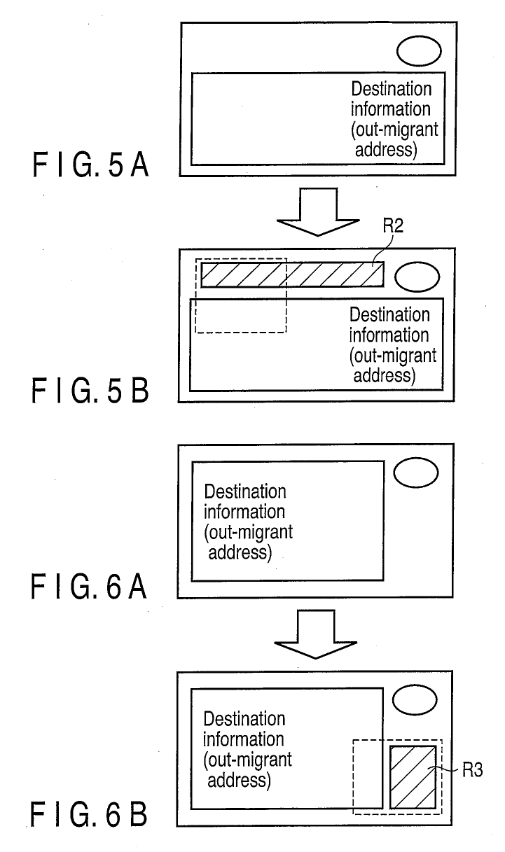

Moreover, FIG. 5A is a view showing an example of a paper sheet to which the label R1 cannot be attached without overlapping the destination information. That is, in the paper sheet depicted in FIG. 5A, such a region where the label R1 can be attached without overlapping the destination information as shown in FIG. 3B or 4B is not present.

For example, in such a paper sheet as depicted in FIG. 5A, even if the attaching position of the label R1 is set on the upper left side as indicated by a dotted line in FIG. 5B, the destination information description region overlaps the attaching position of the label R1. However, in FIG. 5A, a region where the destination information is not written is present oh the upper side of the horizontally long paper sheet.

FIG. 5B shows a state that a label R2 having a shape different from that of the label R1 is attached to an upper region of a paper sheet. The label R2 shown in FIG. 5B has a horizontally long shape. Therefore, the label R2 is suitable for being attached to a vacant region on an upper side or a lower side (or areas on both sides of a vertically long paper sheet). That is, when the label R2 having the shape different from that of the label R1 is selected as shown in FIG. 5B, the label can be attached to such a paper sheet as depicted in FIG. 5A without overlapping the destination information. Furthermore, the standard attaching position is set with respect to the label R2. In regard to the label R2, a position deviating from the standard attaching position can be set as an attaching position.

Furthermore, FIG. 6A is also a view showing an example of a paper sheet to which the label R1 cannot be attached without overlapping the destination information. That is, in the paper sheet depicted in FIG. 6A, such a region where the label R1 can be attached without overlapping the destination information as depicted in FIG. 3B or 4B is not present.

For example, in such a paper sheet as shown in FIG. 6A, even if the attaching position of the label R1 is set to the lower right side of the paper sheet, the destination information description region overlaps the attaching position of the label R1. However, in FIG. 6A, the largest vacant region (a region where the destination information is not written) is present on the lower right side of the horizontally long paper sheet.

FIG. 6B shows a state that a label R3 having a shape different from that of the label R1 is attached to a region on the lower right side of a paper sheet. A size of the label R3 depicted in FIG. 6B is smaller than that of the label R1. Therefore, the destination information of a new address is printed small on the label R3 as long as the information can be identified as compared with the label R1. Since the label R3 is smaller than the label R1, the label R3 may be possibly attached even to a region where the label R1 cannot be attached. That is, when the label R3 smaller than the label R1 in size is selected as shown in FIG. 6B, the label can be attached to such a paper sheet as shown in FIG. 6A without overlapping the destination information. Furthermore, the standard attaching position is set with respect to the label R3. In regard to the label R3, a position deviating from the standard attaching position can be set as an attaching position.

According to the above-described first processing example, the sorting device judges whether destination information written on a paper sheet is for an out-migrant based on information of the out-migrant registered in the database, and it attaches a label having information of a new address printed thereon to the paper sheet to prevent the label from overlapping a destination information description region when it is determined that the destination information of the paper sheets is for the out-migrant. Furthermore, if there is no region where the label is attached without overlapping the destination information description region of the paper sheet, the sorting device sorts out the paper sheet to a predetermined sorting pocket without attaching the label. According to the first processing example, humans can assuredly visually confirm the destination information written on the paper sheet for the out-migrant from the beginning.

A second processing example will now be described.

The second processing example is processing for improving an identification accuracy for an out-migrant and an in-migrant based on the character recognition processing. When address information included in destination information obtained by the OCR coincides with address information of out-migrant information like the first processing example, a judgment must be made upon whether receiver information included in the destination information corresponds to an out-migrant or an in-migrant in order to determine which one of the out-migrant or the in-migrant is a destination of the paper sheet.

For example, the receiver information included in the destination information is determined by comparing a similarity with respect to the out-migrant information with a similarity with respect to the in-migrant information to select one of the out-migrant and the in-migrant. However, simple character recognition has the possibility of erroneously recognizing the receiver information. The receiver information recognition processing is processing of identifying which one of an out-migrant and an in-migrant a receiver corresponds to. Therefore, it is presumable that considering a tendency that a receiver is an out-migrant and a tendency that the receiver is an in-migrant results in an improvement in a recognition accuracy for the receiver information.

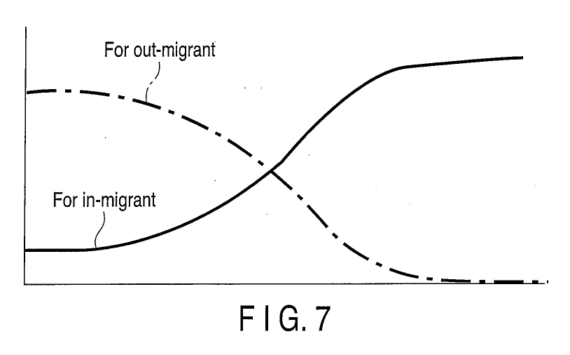

FIG. 7 is a view showing an example of an aged change of rates of postal matters for an out-migrant and postal matters for an in-migrant in given address information.

As shown in FIG. 7, usually, the postal matters for the out-migrant are reduced as time elapses, and the postal matters for the in-migrant are increased as the time elapses. Further, when a fixed period passes, a large part of the postal matters is for the in-migrant, and the number of the postal matters for the out-migrant is very small. It is presumable that carrying out the receiver information identification processing considering such a tendency enables improving a recognition accuracy of the receiver information. That is, in the second processing example, time passage information after registration of address information of an out-migrant as relocation information registered in the destination information database is reflected in a recognition result in the receiver information recognition processing. As a result, in the second processing example, erroneous reading that occurs between the out-migrant and the in-migrant can be reduced.

A flow of the second processing example will now be described.

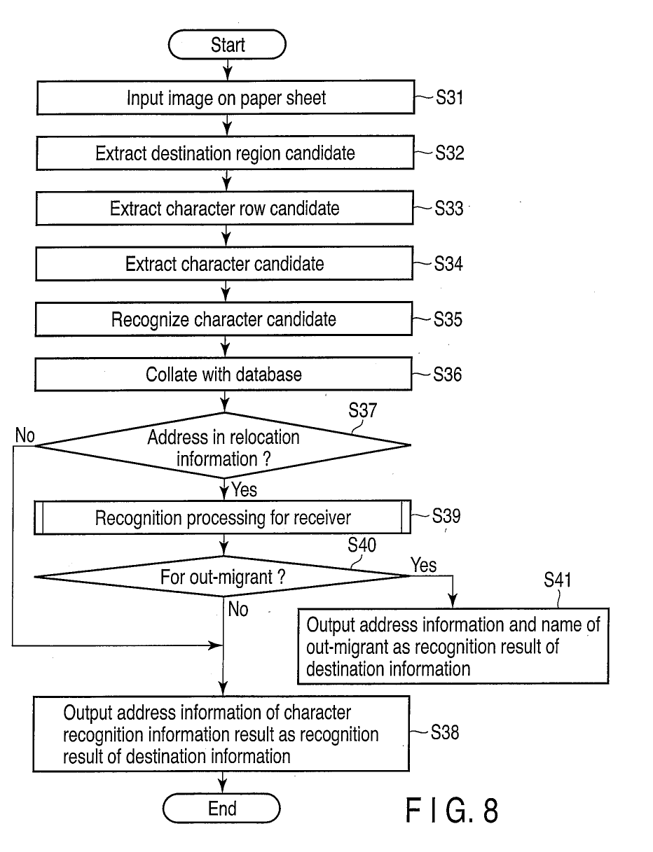

FIG. 8 is a flowchart showing a flow of destination information recognition processing according to the second processing example.

First, an image on a paper sheet read by the scanner 14 is input to the judgment unit 21 in the control unit 11 (a step S31). When the image of the paper sheet is input, the judgment unit 21 first executes destination information recognition processing by using the character recognition unit 22 (steps S32 to S36). The character recognition unit 22 first extracts character region candidates each of which seem like a destination information description region (a step S32). The character recognition unit 22 extracts character row candidates from the extracted character region candidates (a step S33). When the character region candidates are extracted, the character recognition unit 22 extracts character candidates for each character from the extracted character row candidates (a step S34).

When the character candidates are extracted, the character recognition unit 22 executes recognition processing with respect to the extracted character candidates for each character (a step S35). A similarity with respect to the character candidate for each character can be obtained in the character candidate recognition processing. Combining recognition results of the character candidates for each character enables obtaining candidates for destination information. In this example, first, it is assumed that address information included in destination information is a recognition target. When the destination information candidates (address information candidates) are obtained, the character recognition unit 22 collates the obtained address information candidates with each address information registered in the destination DB 6 (a step S36). As a result, the character recognition unit 22 specifies address information as the most reliable destination information.

When the most reliable address information is specified, the judgment unit 21 confirms whether the address information recognized by the character recognition unit 22 coincides with address information included in relocation information (a step S37). When the address information recognized by the character recognition unit 22 does not coincide with the address information of the relocation information (the step S37, NO), the judgment unit 21 outputs the address information obtained at the step S36 to the control unit 11 as a recognition result of the destination information of the paper sheet (a step S38).

Furthermore, when it is confirmed that the address information recognized by the character recognition unit 22 coincides with the address information of the relocation information (the step S37, YES), the judgment unit 21 executes recognition processing for the receiver information included in the destination information detected from the image on the paper sheet by the character recognition unit 22 (a step S39). The receiver information is written on the paper sheet as character information following the address information obtained at the step S36. Therefore, the character recognition unit 22 recognizes the character information following the address information to recognize the receiver information. Moreover, in recognition processing for the receiver information with respect to the relocation information, which one of the out-migrant and the in-migrant the receiver corresponds to is judged. At this time, in the second processing example, the receiver information is recognized based on a recognition result weighted in accordance with an elapsed time from a registration date and hour of the relocation information. Such receiver recognition processing will be described later in detail.

When it is recognized that the receiver is not the out-migrant based on the receiver recognition processing (a step S40, NO), the judgment unit 21 outputs the address information obtained at the step S36 to the control unit 11 as a recognition result of the destination information (a step S38).

Additionally, when it is recognized that the receiver is the out-migrant based on the receiver recognition processing (the step S40, YES), the judgment unit 21 outputs the current address information of the out-migrant included in the relocation information to the control unit 11 as a recognition result of the destination information (a step S41).

According to the above-described processing, in regard to the paper sheet for the out-migrant having address information before move-out written thereon, the current address information of the out-migrant (address information of a new address) read from the destination information database can be output as the destination information of the paper sheet.

Recognition processing for a receiver as the second processing example will now be described.

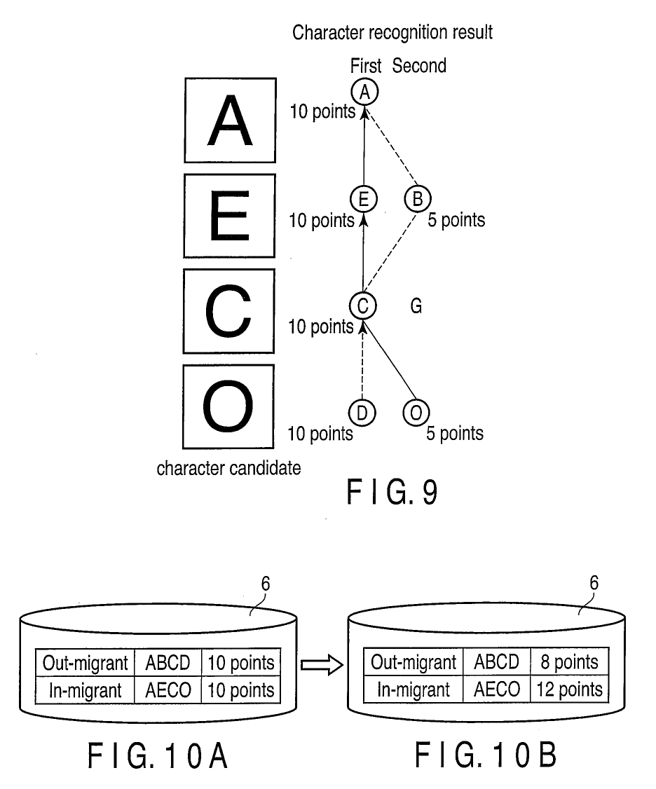

FIG. 9 is a view showing an example of a recognition result with respect to receiver information. Furthermore, each of FIGS. 10A and 10B is a view showing an example of relocation information registered in the destination information database 6.

In the example shown in FIG. 9, a first character is “A”, and it is assumed that an out-migrant registered in the relocation information is “ABCD” and an in-migrant is “AECO”. In the example shown in FIG. 9, in regard to a second character, a first candidates is “E” and a second candidate is “B”. In regard to a third character, a first candidate is “C” and a second character is “G”. Moreover, in regard to a fourth character, a first candidate is “D” and a second candidates is “O”.

Here, it is determined that the first candidate of each character has 10 points and the second candidate of the same has 5 points. However, as to the third character, both the out-migrant and the in-migrant do not include the character “G”. Therefore, it is determined that the third character is the first candidate “C”. It is to be noted that the turned character as the first character is also a first candidate having 10 points. Then, a total of points for the respective characters in “ABCD” of the out-migrant is 10+10+10+5=35 points, and a total of points for the respective characters in “AECO” of the in-migrant is also 10+5+10+10=35 points.

Additionally, points to be added are also set with respect to entire “ABCD” of the out-migrant or entire “AECO” of the in-migrant besides the points for the respective characters. For example, as shown in FIG. 10A, when the points to be added for “ABCD” of the out-migrant is 10 points, a total of points for “ABCD” is 35+10=45 points. When points to be added for “AECO” of the in-migrant are 10 points, a total of points for “AECO” of the in-migrant is also 35+10+45 points.

Like the above-example, when the points for “ABCD” of the out-migrant are equal to the points for “AECO” of the in-migrant, a comprehensive evaluation value (a total points) for “ABCD” of the out-migrant is equal to a comprehensive evaluation value (total points) for “ABCD” of the out-migrant if the same total points of the out-migrant obtained from the recognition result for the respective characters are equal to those of the in-migrant. Contrary, if the points for “ABCD” of the out-migrant are different from the points for “AECO” of the in-migrant even though the total points of the out-migrant obtained from the recognition result for the respective characters are equal to the total points of the in-migrant, there is a difference between a comprehensive evaluation value for “ABCD” and a comprehensive evaluation value for “AECO”, and hence comparing both the comprehensive evaluation values with each other enables judging whether the receiver information corresponds to the out-migrant or the in-migrant.

In the second example, the points to be added to a character string of the out-migrant (e.g., “ABCD”) and the points to be added to a character string of the in-migrant (e.g., “AECO”) are not always fixed points and they can be changed in accordance with rates of paper sheets for the out-migrant and paper sheets for the in-migrant. For example, if paper sheets are postal matters, rates of the paper sheets for the out-migrant and the paper sheets for the in-migrant vary with time passage as shown in FIG. 7. In the example depicted in FIG. 7, as time advances, the paper sheets for the out-migrant are reduced, and the paper sheets for the in-migrant are increased. In such a case, with time passage after registration of the relocation information, the points to be added to the character string of the out-migrant are changed to be reduced, and the points to be added to the character string of the in-migrant are changed to be increased.

For example, when three months have passed from registration of the relocation information, as shown in FIG. 10B, points to be added to the out-migrant are provided by reducing 2 points from 10 points as reference points, and points to be added to the in-migrant are provided by adding 2 points to the 10 points as the reference points. In this case, the points for “ABCD” of the out-migrant are 8 points, and the points for “AECO” of the in-migrant are 12 points. In this case, a comprehensive evaluation value for the out-migrant is 35+8=43 points, and a comprehensive evaluation value for the in-migrant is 35+12=48 points.

That is, when a total number of points of the out-migrant obtained from a recognition result for each character in the receiver information is equal to that of the in-migrant, since points to be added to the in-migrant are increased if three months have passed from registration of the relocation information, the receiver information is determined to correspond to the in-migrant. Such a judgment result is not based on a result of simple character recognition alone, but it is determined in accordance with rates of paper sheets for the out-migrant and paper sheets for the in-migrant which are statistically assumed. That is, according to the second processing example, it can be expected that a highly accurate recognition result according to a tendency in an operating conformation can be obtained as well as a similarity of each character.

A flow of recognition processing of a receiver as the second processing example will now be described in detail.

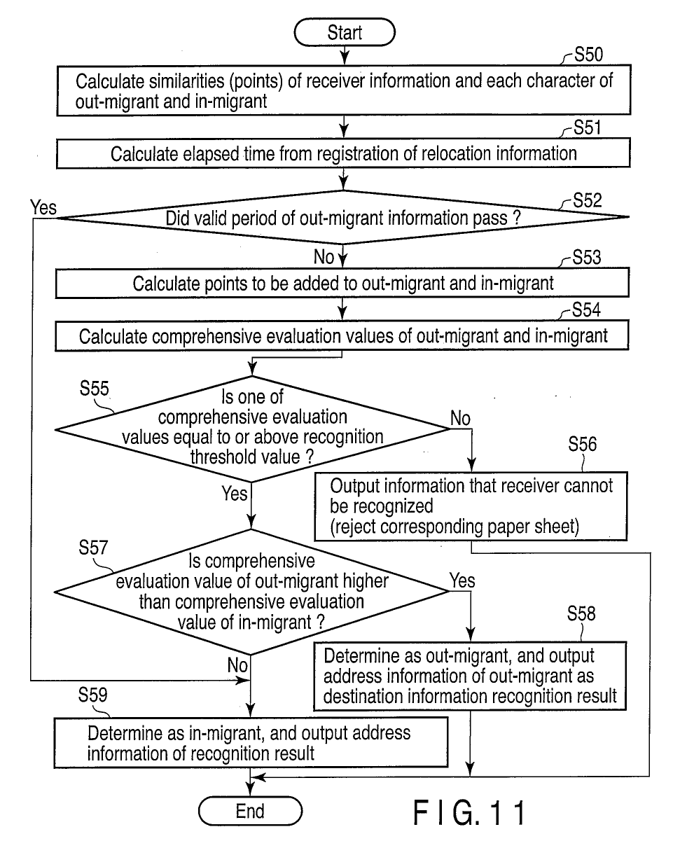

FIG. 11 is a flowchart for explaining a flow of the recognition processing for the receiver.

As described above, in the second processing example, points according to an elapsed time from registration of the relocation information are set to each of a character string of an out-migrant included in the relocation information and a character string of an in-migrant. In the following second processing example, it is determined that the points are determined in accordance with a model representing rates of paper sheets for the out-migrant and paper sheets for the in-migrant (in this example, such a graph as depicted in FIG. 7 is assumed).

First, in such processing as depicted in FIG. 8, it is assumed that an address information recognition result coincides with address information of given relocation information. In this case, the judgment unit 21 calculates points indicative of similarities with respect to respective characters of an out-migrant and an in-migrant included in the relocation information with respect to respective characters in receiver information by using the character recognition unit 22 (a step S50). Furthermore, the judgment unit 21 acquires a current date and hour from a non-illustrated clock or the like to calculate an elapsed time from a registration date and hour of the relocation information (a step S51).

When the elapsed time from the registration date and hour is calculated, the judgment unit 21 judges whether the elapsed time exceeds a valid period for information concerning the out-migrant (a step S52). It is assumed that a fixed period is set as the valid period for the information concerning the out-migrant, for example. Such a valid period is a period during which a service for performing sorting is provided with respect to the out-migrant by using an original address, and it is set in accordance with an operating conformation. However, like the later-explained fourth processing example, effectiveness of the information concerning the out-migrant may be set in accordance with processing performance without setting a predetermined valid period. In this case, the processing at the step S52 is omitted.

When it is determined from the judgment that the elapsed time from the registration date and hour exceeds the valid period (the step S52, YES), the judgment unit 21 determines that the paper sheet is for the in-migrant and outputs the address information of the in-migrant (address information obtained as a recognition result) to the control unit 11 (a step S59). However, when a similarly of each character in the receiver information and each character of the in-migrant is low (i.e., when a similarity of the entire receiver information and the entire in-migrant is low), destination information of the paper sheet is determined to be beyond recognition and processed, and hence the judgment unit 21 may output to the control unit 11a message that the destination information cannot be recognized.

Further, when it is determined from the judgment that the elapsed time from the registration date and hour is within the valid period (the step S52, NO), the judgment unit 21 calculates points to be added to the out-migrant and the in-migrant based on the calculated elapsed time (a step S53). The points to be added to the out-migrant and the in-migrant with respect to the elapsed time are calculated based on a preset arithmetic operation model. As a predetermined arithmetic operation model, there can be considered a table indicative of point to be added to the out-migrant and the in-migrant associated with the elapsed time or a computational expression for calculating the points added to the out-migrant and the in-migrant by assigning the elapsed time, for example.

When the points to be added to the out-migrant and the in-migrant are calculated, the judgment unit 21 adds the calculated addition points to a total of points as a recognition result for each character (a step S54). That is, the judgment unit 21 adds the points which are to be added to the out-migrant to a value obtained by totalizing points for respective characters (corresponding to similarities for respective characters) of the out-migrant for respective characters in the receiver information. The added points are determined as a comprehensive evaluation value for the out-migrant. Further, the judgment unit 21 adds the points which are to be added to the in-migrant to a value obtained by totalizing points for respective characters (corresponding to similarities for respective characters) of the in-migrant for respective characters in the receiver information.

When the comprehensive evaluation values for the out-migrant and the in-migrant are calculated, the judgment unit 21 judges whether at least one of the comprehensive evaluation values for the out-migrant and the in-migrant is equal to or above a predetermined recognition threshold value (a step S55). When both the comprehensive evaluation value for the out-migrant and the comprehensive evaluation value for the in-migrant are less than the predetermined recognition threshold value (the step S55, NO), the judgment unit 21 determines that the receiver information does not correspond to the out-migrant and the in-migrant. In this case, the judgment unit 21 outputs to the control unit 11a message that the receiver information cannot be recognized (a step S56). Upon receiving this result, the control unit 11 executes processing for accumulating the paper sheet in a reject pocket.

Moreover, when the judgment has revealed that at least one of the comprehensive evaluation value for the out-migrant and the comprehensive evaluation value for the in-migrant is equal to or above the predetermined recognition threshold value (the step S55, YES), the judgment unit 21 determines that the receiver information corresponds to the out-migrant. In this case, the judgment unit 21 judges whether the comprehensive evaluation value for the out-migrant is higher than the comprehensive evaluation value for the in-migrant (a step S57). When this judgment has revealed that the comprehensive evaluation value for the out-migrant is higher than the comprehensive evaluation value for the in-migrant (the step S57, YES), the judgment unit 21 outputs to the control unit 11 information indicating that the receiver is the out-migrant and current address information of the out-migrant (address information of a new address) (a step S58). In this case, the control unit 11 executes sorting processing with respect to the paper sheet based on the address information of the new address.

Further, when it is determined from the judgment that the comprehensive evaluation value for the out-migrant is not higher than the comprehensive evaluation value for the in-migrant (i.e., when the comprehensive evaluation value for the in-migrant is higher than the comprehensive evaluation value for the out-migrant, or when the comprehensive evaluation value for the in-migrant is equal to the comprehensive evaluation value for the out-migrant) (the step S57, NO), the judgment unit 21 determines that the receiver information corresponds to the in-migrant. In this case, the judgment unit 11 outputs to the control unit 11 the address information of the in-migrant (address information obtained as a recognition result) (a step S59). In this case, the control unit 11 carries out sorting processing with respect to the paper sheet based on the address information obtained as the recognition result. It is to be noted that the judgment unit 21 may notify the control unit 11 of information indicating that the receiver is determined to be the in-migrant as required.

A third processing example will now be described.

As explained above, the sorting device main body 4 transmits a scan image of a paper sheet whose address information cannot be identified to the VCS unit 5. Furthermore, the sorting device main body 4 gives the paper sheet an ID code, and accumulates it in a reject sorting pocket. The VCS unit 5 temporarily accumulates the image of the paper sheet supplied from the sorting device main body 4 in the information storage distribution unit 31. The information storage distribution unit 31 sequentially distributes the accumulated images of the paper sheets to the respective information input devices 32.

A human (an operator) sees the image of the paper sheet displayed in the display unit and inputs destination information to each information input device 32 through the keyboard. In general, in the information input device 32, address information included in the destination information is input from the image of the paper sheet to the information input device 32 as information required for sorting processing. For example, in the sorting processing for a postal matter, an operating conformation that a postal code and a block number alone which are given to the postal matter are input through the keyboard is often adopted in the information input device 32.

As described above, the operator inputs the address information based on the image of the paper sheet displayed in the display unit in the information input device 32. Therefore, in the information input device 32, even if the destination information written on the paper sheet is for an out-migrant, the address information (an address of an in-migrant) written on the paper sheet is input through the keyboard. When coding processing (input through the keyboard) is completed in this state, the paper sheet for the out-migrant is processed based on the address information of an old address (address information of the in-migrant).

Thus, as the third processing example, the information input device 32 confirms whether the address information input by the operator through the keyboard coincides with address information in relocation information registered in the destination DB 6. When the address input through the keyboard coincides with the address in the relocation information, the information input device 32 displays a warning message to urge the operator to select the out-migrant or the in-migrant. As a result, the operator recognizes that the address information input through the keyboard is the relocation information and he/she must select the out-migrant or the in-migrant as a receiver. When the operator recognizes that the receiver must be selected, he/she selects one of the out-migrant or the in-migrant as the receiver of the paper sheet based on the image of the paper sheet displayed in the display unit in the information input device 32.

As the warning message, one that calls the operator's attention to the fact that the address information input through the keyboard is the relocation information can suffice. For example, as the warning message, blinking a display screen or generating beep sound can be considered.

Furthermore, to urge selection of the out-migrant and the in-migrant, the information input device 32 displays a name of the out-migrant and a name of the in-migrant registered as the relocation information in the display unit in such a manner that they can be selected. In response to this display, the operator selects one of the out-migrant and the in-migrant displayed in the display unit. However, when it is determined that the receiver is not the out-migrant and the in-migrant, the information input device 32 can input information that the receiver is unclear or the destination information is invalid through the keyboard.

When the operator selects the out-migrant, the information input device 32 outputs address information of the out-migrant (address information of a new address) included in the relocation information rather than the address information input by the operator through the keyboard and information indicating that the paper sheet is a paper sheet for the out-migrant as a result of coding processing. When the operator selects the in-migrant, the information input device 32 outputs the address information input by the operator through the keyboard as a result of the coding processing.

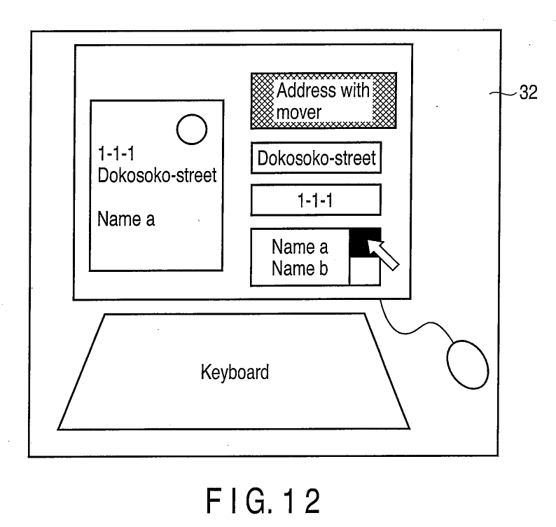

FIG. 12 is a view showing a display example when the address information in the relocation information is input through the keyboard in the information input device 32.

First, it is assumed that the operator inputs the address information in the relocation information by using the keyboard of the information input device 32. The information input device 32 accesses the destination DB 6 when a city block in the address information is input through the keyboard, and it confirms whether address information in relocation information that coincides with the address information input through the keyboard is present. When the address information input through the keyboard coincides with the address information in the relocation information, the information input device 32 displays such a screen that urges selection of a receiver as depicted in FIG. 12 in the display unit.

In the example shown in FIG. 12, a paper sheet image display section, an input result display section, a warning message display section and a receiver (an out-migrant and an in-migrant) selecting section are displayed in the display unit. An image of a paper sheet read by the scanner 14 is displayed in the paper sheet image display section. The address information input by the operator through the keyboard is displayed in the input result display section. A guide message indicating that the input address information coincides with the relocation information (an address with a mover) is displayed in the warning message display section.

That is, when the address information displayed in the input result display section coincides with the address information of the relocation information registered in the destination DB 6, the warning message display section indicating that the address information corresponds to the address with a mover is displayed. Further, in the receiver selecting section, a selecting section for selecting either the out-migrant or the in-migrant a receiver written in the paper sheet corresponds to is displayed. In the display example shown in FIG. 12, “NAME a” as an out-migrant and “NAME b” as an in-migrant are displayed in the receiver display section. The out-migrant and the in-migrant displayed in the receiver display section can be selected by using a mouse or the keyboard.

In such display as depicted in FIG. 12, the operator confirms a name of the receiver from the image of the paper sheet, and selects a corresponding person from those displayed in the selecting section by using the mouse or the keyboard. As a result, when the address information input by the operator through the keyboard coincides with the relocation information, the operator can confirm whether the receiver is the out-migrant or the in-migrant. Furthermore, when the operator selects the out-migrant, address information of the out-migrant (address information of a new address) included in the relocation information is output as a result of the coding processing. Consequently, even if the receiver is the out-migrant, the current address information can be obtained.

A fourth processing example will now be described.

As described above, in regard to postal matters, paper sheets for an out-migrant are reduced with time. In a general operating conformation, postal matters are subjected to processing that transfers paper sheets for an out-migrant to a new address during a predetermined transfer period. In this case, when the transfer period passes, the processing for transferring the paper sheets for the out-migrant is aborted. However, how paper sheets for an out-migrant are reduced differs depending on each receiver. That is, if how paper sheets for an out-migrant differs depending on each receiver, it is considered that setting an appropriate period for each receiver as the transfer period during which the transfer processing using the relocation information is executed is efficient.

Thus, in the fourth processing example, relocation information registered in the destination information database (the destination DB) 6 is appropriately (periodically) adjusted. For example, in the fourth processing example, judgment results of an out-migrant and an in-migrant with respect to each relocation information are stored, and each relocation information is adjusted in accordance with rates of the out-migrant and the in-migrant in an actual judgment result. Here, it is assumed that the number of paper sheets determined to be directed to an out-migrant and the number of paper sheets determined to be directed to an in-migrant are counted in accordance with each address information of each relocation information. In this case, when the number of paper sheets for the out-migrant in a fixed period is equal to or less than predetermined threshold value, an operator or an administrator is urged to delete the relocation information, or this information is automatically deleted from the destination DB 6. As a result, the efficient management of the destination DB (the relocation information) according to an actual processing situation can be realized.

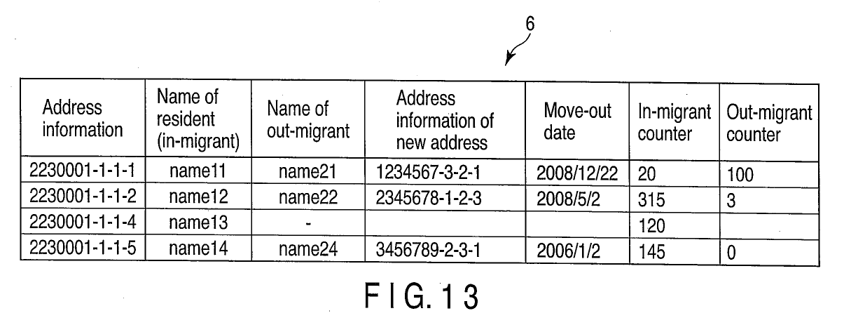

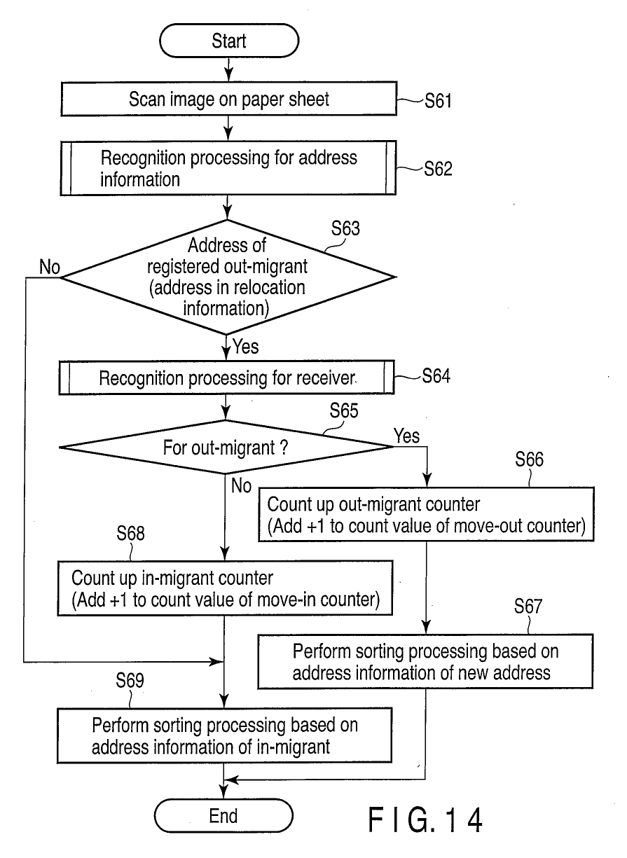

FIG. 13 is a view showing an example of relocation information in the destination information database 6.

In the example depicted in FIG. 13, address information, a name of a resident (an in-migrant), a name of an out-migrant (a previous resident), a move-out date, an in-migrant counter (the number of postal matters for the in-migrant), an out-migrant counter (the number of postal matters for the out-migrant) and others are registered as each relocation information. However, the example in FIG. 13 shows not only destination information as the relocation information in which information concerning the out-migrant is registered but also destination information having no information concerning the out-migrant registered therein.

The name of a resident is information indicative of a person who currently lives at a location corresponding to the address information. When the destination information is the relocation information, a name of a resident is a name of an in-migrant (a current resident). The name of an out-migrant is information indicative of a person who has previously lived at a location corresponding to the address information. When the destination information is the relocation information, the name of an out-migrant is not registered, and hence whether the destination information is the relocation information can be judged based on whether the name of the out-migrant is registered. The move-out date is information indicative of a date that the out-migrant moved out.

The in-migrant counter shows a value obtained by counting the number of paper sheets for an in-migrant. When a paper sheet having corresponding address information is determined to be directed to an in-migrant, the in-migrant counter is incremented (1 is added). Furthermore, the out-migrant counter shows a value obtained by counting the number of paper sheets for an out-migrant. When it is determined that a paper sheet having corresponding address information is for an out-migrant, the out-migrant counter is incremented (1 is added). Each of the in-migrant counter and the out-migrant counter count the number of paper sheets for an in-migrant or the number of paper sheets for an out-migrant during a given period. Therefore, each of the in-migrant counter and the out-migrant counter may be initialized every given period, or it may hold a value obtained by counting every predetermined period (e.g., every month).

In the fourth processing example, in regard to such relocation information as depicted in FIG. 13, each of the in-migrant counter and the out-migrant counter counts the number of paper sheets for an in-migrant or the number of paper sheets for an out-migrant in the sorting processing for regular paper sheets. As a result, information indicative of the number of paper sheets for an in-migrant and the number of paper sheets for an out-migrant in a predetermined period is registered in each relocation information.

Further, in the fourth processing example, adjustment according to rates of the number of paper sheets for an in-migrant and the number of paper sheets for an out-migrant is periodically performed with respect to each relocation information. For example, when rates of the number of paper sheets for an in-migrant and the number of paper sheets for an out-migrant during a predetermined period become equal to or below reference values (threshold values) required for deleting information, a guide message indicating that information concerning the out-migrant in corresponding relocation information is deleted or information concerning the out-migrant is deleted is provided. It is to be noted that, in the structural example depicted in FIG. 13, deleting the information concerning an out-migrant also means changing corresponding relocation information to regular destination information.

A flow of the fourth processing example will now be described.

FIG. 14 is a flowchart for explaining a flow of sorting processing for paper sheets including counting processing for paper sheets according to the fourth processing example.

First, in the sorting device main body 4, an image of a paper sheet taken out from the supply unit 12 is read by the scanner 14 (a step S61). The image read by the scanner 14 is supplied to the character recognition unit 22 in the control unit 11. The character recognition unit 22 executes character recognition processing for recognizing address information included in destination information from the image read by the scanner 14 (a step S62). However, in regard to a paper sheet having a barcode printed thereon, the barcode reader 15 recognizes destination information represented by the barcode. It is to be noted that the address information recognition processing can be realized by the same processing as that described as the first or second processing example.

When an address information recognition result can be obtained from the character recognition unit 22, the judgment unit 21 judges whether the address information as the recognition result coincides with address information in destination information (relocation information) having a registered out-migrant (a step S63). When the address information as the recognition result coincides with the address information in the relocation information (the step S63, YES), the judgment unit 21 uses the character recognition unit 22 to recognize receiver information (e.g., a name of a receiver) included in the destination information written on the paper sheet (a step S64). In this receiver recognition processing, whether the receiver written on the paper sheet is an out-migrant or an in-migrant is judged. It is to be noted that the receiver recognition processing can be realized by the same processing as that described in the second processing example.

When the receiver written on the paper sheet is recognized as an out-migrant (the step S65, YES), the judgment unit 21 counts up the out-migrant counter in the relocation information (a step S66). In this case, the judgment unit 21 outputs address information of a new address of the out-migrant to the output unit 11 as a recognition result. Upon receiving such an address information recognition result, the control unit 11 sorts out the paper sheet based on the address information of the new address (a step S67).

When the receiver written on the paper sheet is recognized as an in-migrant (the step S65, NO), the judgment unit 21 counts up the in-migrant counter in the relocation information (a step S68). In this case, the judgment unit 21 outputs address information obtained by the character recognition (an address of the in-migrant) to the control unit 11 as a recognition result. Upon receiving such an address information recognition result, the control unit 11 sorts out the paper sheet based on the address information of the in-migrant (a step S69).

According to the sorting processing of the four processing example, the number of out-migrants and the number of in-migrants are stored in each relocation information in the destination information database 6. Here, it is assumed that the number of paper sheets for the out-migrant and the number of paper sheets for the in-migrant during a predetermined period in each relocation information are counted up by the out-migrant counter and the in-migrant counter. The relocation information registered in the destination information database 6 is adjusted based on a value of the out-migrant counter and a value of the in-migrant counter.

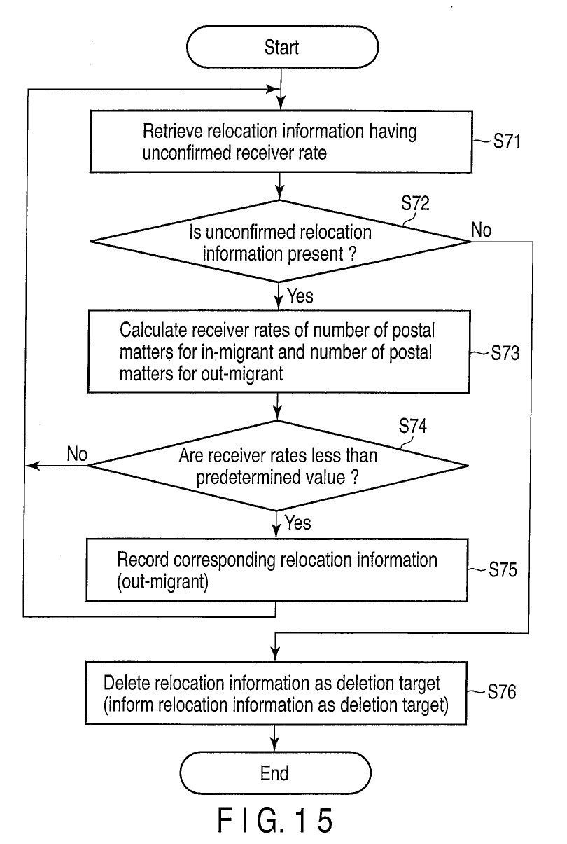

FIG. 15 is a flowchart for explaining a flow of adjustment processing for the destination information database according to the fourth processing example.

The control unit 11 in the sorting device main body 4 periodically adjusts the relocation information registered in the destination information database 6. When adjusting the relocation information, the control unit 11 searches the destination DB 6 for the relocation information as an adjustment processing target (a step S71). When the relocation information as the adjustment processing target has been detected from the destination DB 6 (a step S72, YES), the control unit 11 calculates rates of the number of paper sheets for the in-migrant and the number of paper sheets for the out-migrant (which will be referred to as a receiver rate hereinafter) in the relocation information (a step S73). The rate is calculated from a value of the in-migrant counter and a value of the out-migrant during a predetermined period.

When the receiver rate has been calculated, the control unit 11 judges whether the calculated receiver rate is less than a predetermined deletion reference value used for judging whether the relocation information should be deleted (a step S74). Although the deletion reference value is set in accordance with an operating conformation, setting a value that reduces the number of paper sheets for the out-migrant to approximately ⅕ of the number of paper sheets for the in-migrant can be considered, for example. Furthermore, a threshold value for the number of paper sheets for the out-migrant may be set in place of the deletion reference value for the receiver rate. In this case, when the number of paper sheets for the out-migrant is less than the threshold value during a predetermined period, a conformation that the relocation information is determined as a deletion candidate can be realized.

When the ratio is determined to be less than the deletion reference value based on the judgment (the step S74, YES), the control unit 11 records corresponding relocation information or information indicative of a corresponding out-migrant in a non-illustrated memory as a deletion candidate (a step S75). When the relocation information is recorded in the memory as the deletion candidate, the control unit 11 returns to the step S71 to carry out the processing for searching the destination DB 6 for the next relocation information. Furthermore, when the ratio is determined be not less than the deletion reference value based on the judgment (the step S74, YES), the control unit 11 returns to the step S71 to search the destination DB 6 for the next relocation information without determining the relocation information as a deletion target.

Moreover, when it is determined that relocation information whose rate is unconfirmed is not present in the destination DB 6, i.e., when receiver rates in all the pieces of relocation information registered in the destination DB are confirmed (the step S72, NO), the control unit 11 notifies an administrator or an operator of a guide message indicating that the relocation information recorded as the deletion candidate is to be deleted (a step S76). The administrator or the operator is informed of the guide message indicating that the relocation information is to be deleted by displaying this message in the display unit in a non-illustrated operation panel. When such a guide message is supplied, the administrator or the operator confirms the relocation information to be deleted to instruct deletion of the relocation information. The control unit 11 deletes the relocation information from the destination DB 6 in response to the deletion instruction from the administrator or the operator.

Additionally, as the processing at the step S76, the control unit 11 may delete the relocation information recorded as the deletion candidate from the destination DB 6. In this case, the control unit 11 may inform the administrator or the operator of information indicating that deletion has been carried out. It is to be noted that, if an operating conformation that the relocation information determined as the deletion candidate is automatically deleted from the destination DB 6 is adopted, the control unit 11 may delete the relocation information when the relocation information is determined as the deletion candidate at the step S74.

Since the respective first, second, third and fourth processing examples concern processing for paper sheets for out-migrants, these examples can be combined to be carried out.

For instance, the first processing example is processing for attaching a label to a paper sheet for an out-migrant. That is, like the second, third and fourth processing examples, the first processing example concerns the processing for a paper sheet directed to an out-migrant, it can be readily combined with the second, third or fourth processing example to be carried out, and it can be considered that combining these examples enables obtaining an effect of assuredly processing a paper sheet for an out-migrant.

Further, the second processing example is processing for identifying receiver information included in destination information. That is, since the second processing example concerns processing for a paper sheet directed to an out-migrant like the first, third and fourth processing examples, it can be readily combined with the first, third or fourth processing example to be carried out, and it can be considered that combining these examples enables obtaining an effect of assuredly processing a paper sheet for an out-migrant.

Furthermore, the third processing example concerns processing for inputting through a keyboard (coding) destination information for a paper sheet having address information in destination information having failed in recognition. That is, like the first, second and fourth processing examples, the third processing examples concerns processing for a paper sheet directed to an out-migrant, it can be easily combined with the first, second or fourth processing example to be carried out, and it is considered that combining these examples enables obtaining an effect of assuredly processing a paper sheet for an out-migrant.

Moreover, the fourth processing example is processing concerning update (adjustment of the database) such as deletion of relocation information registered in the destination information database. That is, like the first, second and third processing examples, since the fourth processing example concerns processing for a paper sheet directed to an out-migrant, it can be readily combined with the first, second or the third processing example to be carried out, and it is considered that combining these examples enables obtaining an effect of assuredly processing a paper sheet for an out-migrant.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A paper sheet processing apparatus that processes a paper sheet, comprising:
a storage unit which stores relocation information including information concerning an out-migrant whose address has changed;
a read unit which reads an image on the paper sheet;
a recognition unit which performs character recognition with respect to destination information including address information and receiver information from the image on the paper sheet read by the read unit;
a determination unit which determines whether the paper sheet is for an out-migrant by comparing the destination information as a recognition result obtained by the recognition unit with the relocation information stored in the storage unit;
a judgment unit which judges an attaching position of a label having information concerning an out-migrant given thereto based on a destination information description region on the paper sheet in a case where the determination unit determines that the paper sheet is for the out-migrant; and
a label attachment unit which attaches the label having the information concerning the out-migrant given thereto to the attaching position on the paper sheet determined by the judgment unit.

2. The apparatus according to claim 1, wherein the label attachment unit attaches one selected from a plurality of types of labels to the paper sheet, and
and the judgment unit judges whether attachment of various kinds of selectable labels without overlapping the destination information description region on the paper sheet is possible by the label attachment unit.

3. The apparatus according to claim 1, further comprising an abort unit that aborts attachment of the label to the paper sheet in a case where the judgment unit determines that attachment of the label without overlapping the destination information description region is impossible.

4. The apparatus according to claim 3, further comprising a sorting unit which accumulates paper sheets subjected to abort of attachment of the label in a predetermined sorting opening.

5. A paper sheet processing apparatus which processes a paper sheet, comprising:
a storage unit which stores relocation information including address information with an out-migrant, information indicative of a relocated out-migrant and information indicative of a registration time;
a read unit which reads an image on the paper sheet;
an address recognition unit which performs character recognition with respect to address information included in destination information from the image on the paper sheet read by the read unit; and
a receiver recognition unit which recognizes whether receiver information included in the destination information of the paper sheet is an out-migrant or an in-migrant based on character recognition weighted in accordance with an elapsed time from the registration of the relocation information in a case where the address information as a recognition result obtained by the address recognition unit coincides with the address information of the relocation information.

6. The apparatus according to claim 5, wherein the receiver recognition unit recognizes the receiver information by performing weighting that facilitates recognition of an in-migrant as compared with an out-migrant as the elapsed time from the registration of the relocation information becomes longer.

7. The apparatus according to claim 5, wherein the receiver recognition unit determines that a receiver of the paper sheet is an in-migrant in a case where the elapsed time from the registration of the relocation information is equal to or above a predetermined valid period.

8. A paper sheet processing apparatus which processes a paper sheet, comprising:
a storage unit which stores relocation information including information concerning an out-migrant whose address has changed;
a read unit which reads an image on the paper sheet;
a recognition unit which recognizes destination information including address information and receiver information from the image of the paper sheet read by the read unit; and
an information input unit which accepts input of the destination information through a keyboard in a state where the image on the paper sheet whose destination information cannot be recognized by the recognition unit is displayed, and informs a warning that the destination information input through the keyboard corresponds to the relocation information in a case where the destination information input through the keyboard coincides with the relocation information stored in the storage unit.

9. The apparatus according to claim 8, wherein the information input unit displays information indicative of an out-migrant and information indicative of an in-migrant having the destination information input through the keyboard being included in the relocation information in a case where the destination information input through the keyboard coincides with the relocation information stored in the storing means.

10. The apparatus according to claim 8, wherein the information input unit determines address information of the destination information on the paper sheet as address information of a new address of the out-migrant included in the relocation information in a case where the out-migrant is selected as a receiver of the paper sheet.

11. A paper sheet processing apparatus which processes a paper sheet, comprising:
a storage unit which stores relocation information including information concerning an out-migrant whose address has changed;
a read unit which reads an image on the paper sheet;
a recognition unit which performs character recognition with respect to destination information including address information and receiver information from the image on the paper sheet read by the read unit;
a judgment unit which judges whether a receiver of the paper sheets is an out-migrant or an in-migrant in a case where the address information of the destination information as a recognition result obtained by the recognition unit coincides with the address information of the relocation information stored in the storage unit;
a recording unit which records the number of out-migrants determined by the judgment unit and the number of in-migrants determined by the same in association with the relocation information; and
a counting unit which counts the number of out-migrants and the number of in-migrants recorded by the recording unit in accordance with each relocation information during a predetermined period.

12. The apparatus according to claim 11, further comprising an informing unit that informs that rates of the number of paper sheets for an out-migrant and the number of paper sheets for an in-migrant reach predetermined reference values in a case where the rates of the number of paper sheets for an out-migrant and the number of paper sheets for an in-migrant counted by the counting unit reach the predetermined reference values.

13. The apparatus according to claim 11, further comprising an deletion unit that deletes information concerning the out-migrant as the relocation information stored in the storage unit in a case where the rates of the number of paper sheets for an out-migrant and the number of paper sheets for an in-migrant counted by the counting unit reach the predetermined reference values.

14. A paper sheet processing method comprising:
storing relocation information including information concerning an out-migrant whose address has changed in a storage unit;
reading an image on a paper sheet;
performing character recognition with respect to destination information including address information and receiver information from the read image on the paper sheet;
judging whether the paper sheet is for an out-migrant by comparing the destination information as a recognition result obtained by the character recognition with the relocation information stored in the storage unit; and
attaching a label having information concerning the out-migrant to an attaching position determined based on a destination information description region on the paper sheet in a case where it is determined from the judgment that the paper sheet is for the out-migrant.

15. A paper sheet processing method comprising:
storing relocation information including address information with an out-migrant, information indicative of a relocated out-migrant and information indicative of a registration time in a storage unit;
reading an image on a paper sheet;
performing address recognition with respect to the address information included in the destination information from the read image on the paper sheet based on character recognition processing; and
recognizing whether receiver information included in the destination information of the paper sheet corresponds to an out-migrant or an in-migrant based on character recognition weighted in accordance with an elapsed time from the registration time of the relocation information in a case where the address information as a recognition result obtained by the address recognition coincides with the address information in the relocation information stored in the storage unit

16. A paper sheet processing method comprising:
storing relocation information including information concerning an out-migrant whose address has changed in a storage unit;
reading an image on a paper sheet;
performing character recognition with respect to destination information including address information and a receiver information from the read image on the paper sheet;
accepting input of the destination information through the keyboard in a state that an image of a paper sheet whose destination information cannot be recognized by the character recognition is displayed; and
informing a warning that the destination information input through the keyboard corresponds to the relocation information in a case where the destination information input through the keyboard coincides with the relocation information stored in the storing unit.

17. A paper sheet processing method comprising:
storing relocation information including information concerning an out-migrant whose address has changed in a storage unit;
reading an image on a paper sheet;
performing character recognition with respect to destination information including address information and receiver information from the read image on the paper sheet;
judging whether a receiver of the paper sheet is an out-migrant or an in-migrant in a case where the address information of the destination information as a recognition result based on the character recognition coincides with the address information of the relocation information stored in the storage unit;
recording the number of out-migrants determined as out-migrants and the number of in-migrants determined as in-migrants by the judgment in a recording unit in association with the relocation information; and
counting the number of out-migrants and the number of in-migrants recorded in the recording unit in accordance with each relocation information during a predetermined period.
